(19) United States
(12) Patent Application Publication
(10) Pub. No.: US 2006/0060228 A1
(43) Pub. Date: Mar. 23, 2006

(54) Sump assembly of dishwasher

(75) Inventors: Sang Heon Yoon, Seoul (KR); Nung Seo Park, Bupyeong-gu (KR); Dae Yeong Han, Seoul (KR); Hung Myong Cho, Gimhae-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/102,885

(22) Filed: Apr. 11, 2005

(30) Foreign Application Priority Data
Sep. 17, 2004 (KR) P2004-74476

(51) Int. Cl. B08B 3/00; B08B 3/04

(52) U.S. Cl. 134/56 D; 134/104.2

(57) ABSTRACT

A sump assembly of a dishwasher stores water to be supplied to spray nozzles. The sump assembly includes a sump housing for storing water; a cover for covering the sump housing; and a water guide provided within the sump housing and disposed under the cover, the water guide being directly joined to the cover and having at least one guide passage for outputting water, wherein at least one of the water guide and the cover is partially fused to enable the joining without using a separate locking member.

### CROSS-REFERENCE TO RELATED APPLICATIONS

This application claims the benefit of Korean Application No. 10-2004-0074476 filed on Sep. 17, 2004, which is hereby incorporated by reference.

### BACKGROUND OF THE INVENTION

1. Field of the Invention

The present invention relates to a dishwasher, and more particularly, to a sump assembly of a dishwasher, in which water is stored to be supplied to spray nozzles.

2. Discussion of the Related Art

A general dishwasher is a home appliance for washing tableware and other such articles by spraying water through a set of spray nozzles under high pressure onto the articles being washed, which are typically placed in one or more racks provided inside a tub or washing chamber. Water sprayed inside the washing chamber then drains down into a sump disposed under the tub. A sump assembly, which is supplied with clean water for initiating a washing operation, is used to collect and store the water being sprayed and to supply the stored water to the spray nozzles.

The sump assembly is composed of numerous components assembled into a single module using various locking members. Such assembly, and specifically the number of locking members, consumes excessive assembly time and thus lowers productivity. Moreover, some components of the sump assembly, for example, guide passages for guiding the pumped water to the spray nozzles, consist of sub-components to be joined using one or more of the locking members, creating the potential for leaks and reduced water pressure.

### SUMMARY OF THE INVENTION

Accordingly, the present invention is directed to a sump assembly of a dishwasher that substantially obviates one or more problems due to limitations and disadvantages of the related art.

An object of the present invention is to provide a sump assembly of a dishwasher, by which the configuration of the sump assembly is improved to promote productivity facilitating assembly and reducing assembly time.

Another object of the present invention is to provide a sump assembly of a dishwasher, by which the configuration of the assembly is improved to prevent the pressure of water supplied to spray nozzles from being lowered.

Another object of the present invention is to provide a sump assembly of a dishwasher, by which the configuration of the assembly is improved to reduce leakage.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages in accordance with the purpose of the invention, as embodied and broadly described herein, there is provided a sump assembly of a dishwasher comprising a sump housing storing water, a pump coupled with the sump housing to pump the water, a cover provided to the sump housing to cover, and a water guide provided within the sump housing under the cover, the water guide having at least one guide passage for guiding the pumped water to at least one spray nozzle, the water guide directly joined to the water guide without using a separate locking member.

Preferably, at least one of the water guide and the cover is partially fused to join the water guide and the cover together. The guide passage is defined by a top portion of the water guide and a bottom portion of the cover. In this case, the top portion of the water guide and the bottom portion of the cover are joined together by fusing at least one of the top and bottom portions and pressing the fused portion to joining the water guide and the cover.

Preferably, the water guide includes an upper housing having a top surface provided with the guide passage to be directly joined to a bottom surface of the cover without using a separate locking member and a lower housing provided beneath the upper housing to have a soil chamber where a portion of the pumped water is introduced.

More preferably, the cover comprises a filter situated over the soil chamber to filter the water flooding from the soil chamber. The cover may further include at least one overflow vent for receiving water that has been filtered by passing through the filter to the sump housing and at least one drain aperture for receiving water draining into the sump housing from inside a washing chamber of the dishwasher.

More preferably, the pump includes an impeller situated between the upper and lower housings to pump the water. The water guide further includes a seal situated between the upper and lower housings to prevent the water flowing from the impeller from leaking.

Preferably, the sump assembly further includes at least one locking member simultaneously securing the cover and the water guide to the sump housing. The at least one locking member penetrates the cover and the water guide to be locked to the sump housing. In this case, the cover further includes a hole penetrated by the at least one locking member and the sump housing further includes a boss receiving the at least one locking member.

Preferably, the sump assembly further includes at least one supplementary locking member making the water guide adhere to the cover closely. The at least one supplementary locking member penetrates the cover and is then locked to a top surface of the water guide. Moreover, the sump assembly further includes a nipple assembled to a top surface of the cover by the at least one supplementary locking member to be connected to a connecting pipe communicating with the spray nozzle.

In another aspect of the present invention, there is provided a dishwasher comprising a washing chamber for accommodating articles to be washed; a sump assembly disposed under the washing chamber, the sump assembly comprising: a sump housing for storing water; a cover for covering the sump housing; and a water guide provided within the sump housing and disposed under the cover, the water guide being directly joined to the cover and having at least one guide passage for outputting water; a water supply pump, coupled with the sump housing, for pumping the stored water into the at least one guide passage; and at least one spray arm for spraying the pumped water into the washing chamber toward the accommodated articles.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional diagram of a dishwasher according to the present invention;

FIG. 2 is an exploded view of a sump assembly according to the present invention;

FIG. 3 is a perspective view diagram of the bottom of the upper housing and cover of the sump assembly shown in FIG. 2;

FIG. 4 is another exploded view for illustrating the use of a locking member in assembling the sump assembly shown in FIG. 2; and

FIG. 5 is an exploded view for illustrating the use of a supplementary locking member in assembling the sump assembly shown in FIG. 2.

### DETAILED DESCRIPTION OF THE INVENTION

Reference will now be made in detail to the preferred embodiments of the present invention, examples of which are illustrated in the accompanying drawings. Wherever possible, like reference numbers will be used throughout the drawings to refer to the same or similar parts.

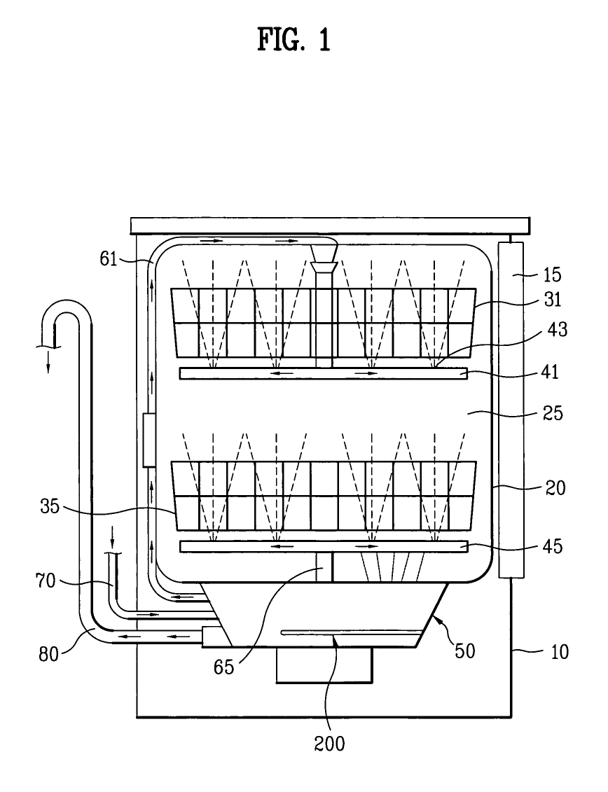

Referring to FIG. 1, illustrating a dishwasher according to the present invention, a tub 20 is provided within a case 10 forming an exterior of a dishwasher, and a door 15 opening/closing the tub is provided to one side of the case. A washing chamber 25 for accommodating articles to be washed is defined by the tub 20, which houses at least one rack, e.g., upper and lower racks 31 and 35, for loading the articles and at least one spray arm, e.g., upper and lower spray arms 41 and 45, which are rotatable when spraying water through a set of spray nozzles 43 arranged adjacent each rack.

A sump assembly 50 for supplying water to the upper and lower arms 41 and 45 is provided within the case 10, and more specifically, under the tub 20. The sump assembly 50 is connected to the upper arm 41 via a first connecting pipe 61 and is connected to the lower arm 45 via a second connecting pipe 65. The sump assembly 50 is supplied with water from an external source (not shown) via a water supply pipe 70 and stores the supplied water to be supplied to one or both of the upper and lower arms 41 and 45 via the first and second connecting pipes 61 and 65, respectively.

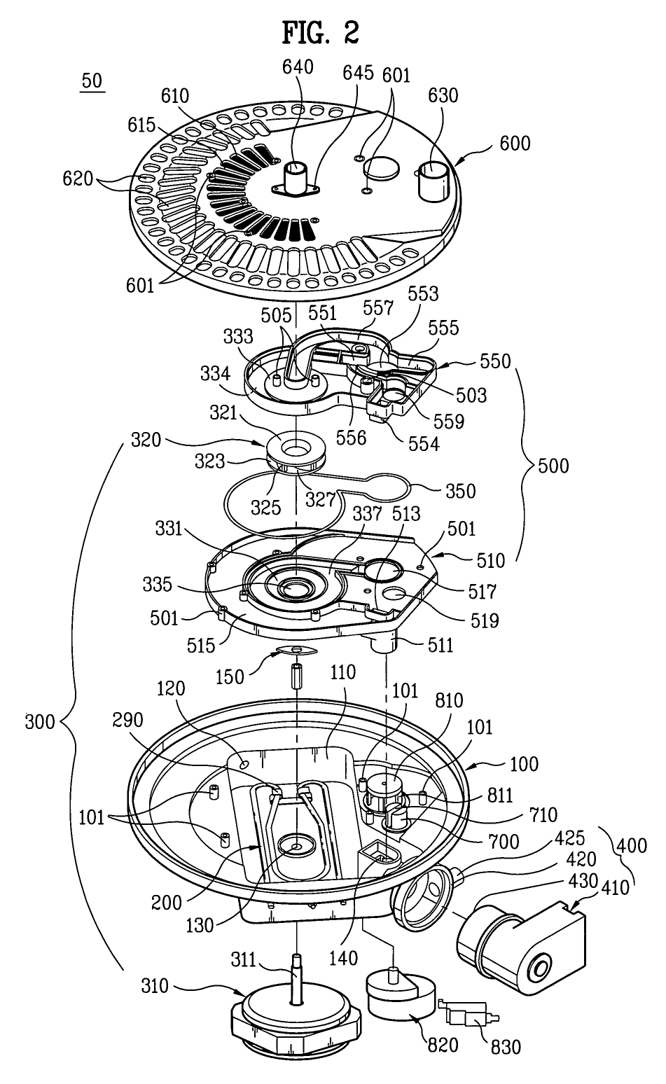

Referring to FIG. 2, detailing a preferred configuration of the sump assembly according to the present invention, the sump assembly 50 includes a sump housing 100 for storing water, a heater assembly 200 installed within the sump housing to heat the stored water, a drain pump 400 for draining the water from the sump housing, a water supply pump 300 for pumping the water from the sump housing into the first and second connecting pipes 61 and 65, a water guide 500 for outputting the pumped (pressurized) water to the first and second connecting pipes, and a cover 600 for covering the sump housing and for filtering water entering the sump housing from the washing chamber 25.

A recess 110 is provided to a bottom center of the sump housing 100 to store the water, and a water supply hole 120 is provided to one side of the recess to be connected to the water supply pipe 70. A drain chamber 140, provided to the sump housing 100 near the recess 110, communicates with the recess via a hole (not shown) formed in one side of the drain chamber and, via its open top, communicates with a soil chamber 515 provided to the water guide 500. The drain pump 400, which communicates with the drain chamber 140, is loaded into a lateral side of the sump housing 100 to expel water from the drain chamber as well as the recess 110 and soil chamber 515.

The drain pump 400 includes a motor 410, an impeller housing 420, and an impeller 430 coupled to the motor via shaft (not shown). The impeller housing 420, which communicates with the drain chamber 140, may be coupled to the lateral side of the sump housing 100 or may be integrally formed with the sump housing. A nipple 425 protrudes from one side of the impeller housing 420 to be connected to a drain hose 80. When fitting the motor 410 to the impeller housing 420, the impeller 430 is inserted in the impeller housing, so that, once the drain pump 400 is actuated, water contained in the recess 110, drain chamber 140, and soil chamber 515 is expelled from the drain chamber 140 via the drain pump and out through the drain hose 80.

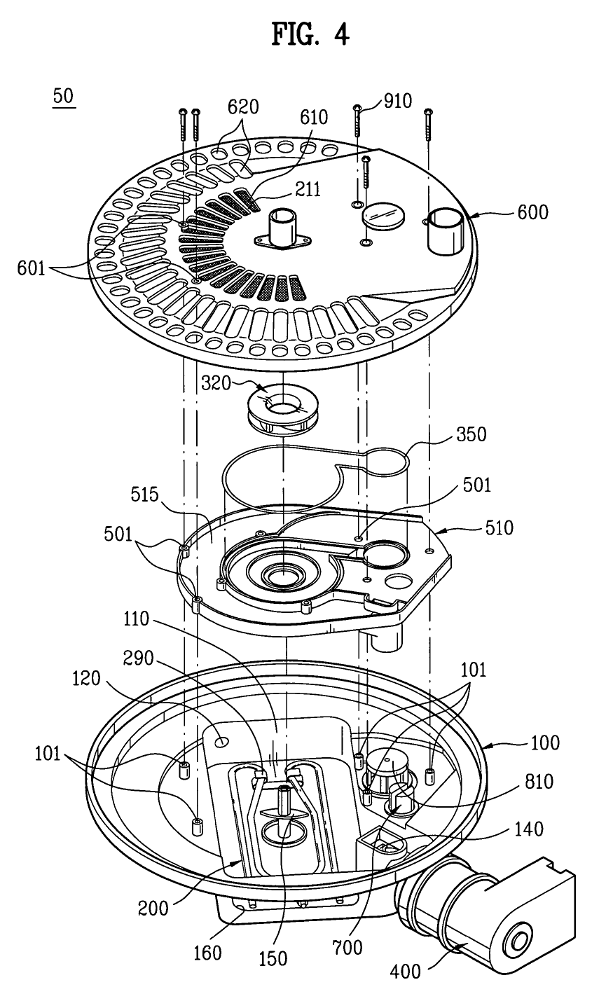

The heater assembly 200 is disposed in the bottom of the sump housing 100, and specifically, on the bottom of the recess 110, and is configured in the sump housing to enable a manual detachment and installation from outside the sump housing via an opening 160 (seen in FIG. 4). The water supply pump 300 pumps the water over the heater assembly 200, which is fixed by a clamp 290, to supply heated water to the spray arms without heat loss. The water supply pump 300 includes a motor 310, an impeller 320, and an impeller housing formed by upper and lower housings (described later) of the water guide 500.

Referring to FIG. 2, the motor 310 is installed under the sump housing 100 such that a shaft 311 of the motor passes through a hole 130 formed in the bottom of the recess 110 to be connected on the other side to a set of disposal blades 150 that is rotated, when the motor is actuated, to grind refuse contained in the water held within the recess. The impeller 320, which is also assembled to the shaft 311, is rotated to pump heated water from the recess 110, by sucking in water axially and discharging the water radially using a plurality of curved blades 325 arranged between upper and lower plates 321 and 323. Thus, water enters the impeller 320 via an inlet (not shown) provided to the lower plate 323, while the upper plate 321 is solid (blocked off) and exits the impeller through a series of outlets 327 provided between the curved blades 325. The shaft 311 is fitted to the lower end of a hub (not shown) centrally provided to the upper plate 321.

The impeller housing of the water supply pump 300 encloses the impeller 320, to guide the water moved by the impeller, and rather than being formed of an independent body, is preferably formed integrally with the body of the water guide 500, which is assembled by coupling a lower housing 510 to an upper housing 550 and thus inherently configures the impeller housing. That is, the lower housing 510 of the water guide 500 has an inlet 335 centrally formed for feeding water from the recess 110 to the impeller 320 and has a top surface formed of a lower seat 331 encircled by a lower water passage 337. The lower seat 331 is recessed to accommodate a lower part of the impeller 320 and encircles the inlet 335, which communicates with the unseen inlet at the bottom of the impeller 320 when seated. Meanwhile, the upper housing 550 of the water guide 500 has a bottom surface formed of an upper seat 333, which is disposed in opposition to the lower seat 331 and is recessed to accommodate an upper part of the impeller 320. Encircling the upper seat 333 is an upper water passage 334 for directing water into an outlet 551 formed at one end of the upper water passage to be thus guided from the upper water passage to an upper surface of the upper housing. Accordingly, once the motor 310 is actuated, the impeller 320 is rotated inside a space defined by the lower and upper seats 331 and 333, so that water stored in the recess 110 of the sump housing 100 enters the impeller 320 via the inlet 335 and is radially discharged to be forced along a water passage defined by the lower and upper water passages 337 and 334 and directed via the outlet 551 to the top surface of the upper housing 550 of the water guide 500. A seal 350 is disposed between the upper and lower housings 550 and 510 to correspond to a connection point between the upper and lower water passages 334 and 337 and the valve receptacle 553, to effectively prevent leakage of the water pumped by the impeller 320 of the water supply pump 300.

Thereafter, the water exiting the water guide 500 is selectively or simultaneously guided into the first and second connecting pipes 61 and 65 via first and second guide passages 555 and 557, respectively, using a diverting valve 810 housed in a valve receptacle 553 formed in the upper housing 550 of the water guide 500 so as to communicate with the outlet 551. The first and second guide passages 555 and 557, formed in the top surface of the upper housing 550 to output guided water to be supplied as pressurized water to the lower and upper and lower arms 41 and 45, respectively, are connected to opposite sides of the valve receptacle 553. The first guide passage 555 extends from the valve receptacle 553 to a perimeter point of the upper housing 550, and the second guide passage 557 extends from the valve receptacle to a central point of the upper housing. Thus, the diverting valve 810, which is loaded in the sump housing 100, enables water flowing from the outlet 551 to be selectively directed into one or both of the first and second guide passages 555 and 557. When the water guide 500 is assembled with the sump housing 100, whereby the diverting valve 810 is inserted into the valve receptacle 553 of the upper housing 550 through a hole 517 correspondingly formed in the lower housing 510, a plurality of passages provided around the diverting valve's circumference enable communication between the first and second guide passages 555 and 557 for a simultaneous water output, while a series of ribs 811 enable the first or second guide passage to be selectively blocked for a selective water output.

The diverting valve 810 is controlled using a drive mechanism comprised of a crank 820 connected to the diverting valve, a linkage 830 connected to the crank, and a power source, e.g., a stepper motor (not shown), connected to the linkage. The linkage 830 makes a rectilinear reciprocation by the step motor, whereas the crank 820 converts the rectilinear reciprocation to a rotational motion of the diverting valve 810. According to a desired dishwasher operation, the drive mechanism rotates the diverting valve 810 so that one of the ribs 811 selectively blocks the first and second guide passage 557 or 555.

After having been pumped by the water supply pump 300, some portion of the water guided to the top surface of the upper housing 550 of the water guide 500 is re-circulated to be used in measuring water contamination levels, filtered, and then returned to the sump housing 100 to be stored in the recess 110. The sump assembly of the present invention achieves these steps through a use of a bypass 556 and a sensor assembly 700 operating in conjunction with the cover 600.

The bypass 556, communicating with the outlet 551 of the water guide 500 and thus receiving a portion of the water pumped by the water supply pump 300, is provided to the top surface of the upper housing 550, and a sensor receptacle 559, forming part of the bypass, receives the sensor assembly 700 for measuring contamination levels present in water introduced into the bypass. Thus, when the water guide 500 is loaded in the sump housing 100, the sensor assembly 700, which is loaded in the sump housing 100, is passed through a hole 519 correspondingly formed in the lower housing 510 and is inserted in the sensor receptacle 559. When thus inserted, a channel 710 formed in the sensor assembly 700 communicates with the bypass 556, allowing water entering the bypass to pass through the channel between opposing elements of an optical emitter/receiver unit (not shown) provided within the sensor assembly 700 on opposite sides of the channel. An optical signal is transmitted through the water flowing in the channel 710, and the sensor assembly 700 determines water contamination levels based on the intensity of a received signal for controlling various dishwasher parameters. Water having passed through the sensor assembly 700 arrives at a first drain 554 of the upper housing 550 provided at one end of the bypass 556 and is then passed to a second drain 513 provided to the lower housing 510 and fitted to the first drain and leading to the drain chamber 140 of the sump housing 100. Hence, a portion of the water reaching the top surface of the upper housing 550 after having been pumped by the water supply pump 300 is shunted through the bypass 556, passed through the sensor assembly 700 and the first and second drains 554 and 513 to be introduced into the drain chamber 140, where it may be expelled via the drain hose 80, but only if the drain pump 400 is actuated. A check valve (not shown), disposed between the drain chamber 140 and the recess 110, is provided to prevent contaminated water in the drain chamber from being introduced into the recess, while allowing draining when the drain pump 400 is actuated. Without an actuation of the drain pump, the water introduced into the drain chamber 140 descends into the drain chamber 140 and may enter the soil chamber 515 of the lower housing 510 via a third drain 511. In doing so, contaminants in the water are precipitated, whereby the heavier contaminants settle into the drain chamber 140 while lighter contaminants settle in the soil chamber 515. Filtering occurs as the water in the soil chamber 515 overflows (exits) through the cover 600.

The cover 600, having a generally disc-like shape, covers the water guide 500 and the sump housing 100 and is disposed atop the upper housing 550 to cover the open tops of the first and second guide passages 555 and 557 of the water guide. Hence, the guide passages leading the pumped water to the spray nozzles are defined by a top surface of the water guide 500 and a bottom surface of the cover 600. To filter the overflowing water from the soil chamber 515, a mesh 610 covers a multitude of overflow vents 615, which are centrally arranged over the soil chamber, and a multitude of drain apertures 620 are provided to a lower perimeter area of the cover 600 to allow the pumped and sprayed water draining inside the tub 20 as well as the filtered water overflowing through the overflow vents to enter the sump housing 100. The water thus guided to the sump housing 100 is all stored in the recess 110. Meanwhile, the pumped water exits the sump assembly 500 via a first nipple 630 extending upward from a perimeter point of the cover 600 and a second nipple 640 extending upward from a central point of the cover 600. The first nipple 630 communicates with the first guide passage 555 of the water guide 500, and the second nipple 640 communicates with the second guide passage 557 of the water guide. The first connecting pipe 61 connected to the upper arm 41 is connected to the first nipple 630, and the second connecting pipe 65 connected to the lower arm 45 is connected to the second nipple 640. Hence, the water introduced into the first guide passage 555 is supplied to the upper arm 41 via the first nipple 630 and the first connecting pipe 61, and the water introduced into the second guide passage 557 is supplied to the lower arm 45 via the second nipple 640 and the second connecting pipe 65.

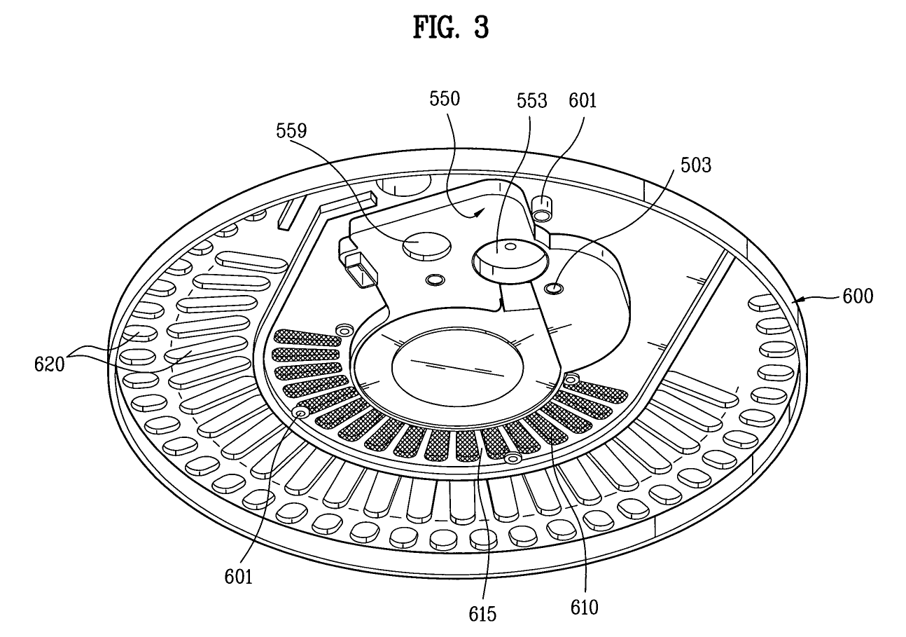

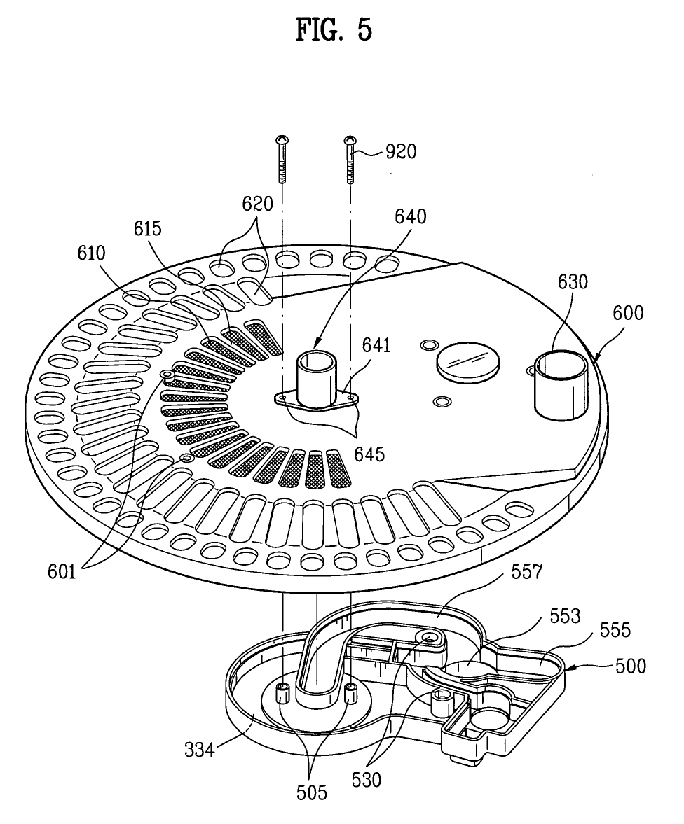

The second nipple 640 may be prepared as a separate body to be installed on the top surface of the cover 600 by a pair of supplementary locking members 920 inserted through a flange 641 (seen in FIG. 5) provided to a lower end of the second nipple and into a pair of bosses 505 correspondingly arranged on the top surface of the upper housing 550, via flange holes 645 and through holes (not shown) correspondingly provided in the cover. Thus, the supplementary members 920 supplement the joining of the water guide 500 to the cover 600, by fixing the second nipple 640 to the top of the cover while tightly joining the upper housing 550 of the water guide to the bottom of the cover, as can be seen in FIG. 3.

In the above-configured sump assembly according to the present invention as shown in FIGS. 2 and 4, the cover 600 and the water guide 500 are simultaneously secured to the sump housing 100 by a set of locking members 910, for example, screws or bolts, passing through a plurality of first holes 601 formed in the cover. The locking members 910 are passed through a corresponding plurality of second and third holes 503 and 501 are respectively provided to each of the upper and lower housings 550 and 510 of the water guide 500 to be received in a plurality of bosses 101 projecting correspondingly from the top surface of the sump housing 100. Thus, the locking members 910 sequentially penetrate the cover 600, the upper housing 550 of the water guide 500, and the lower housing 510 of the water guide 500, to be secured to the sump housing 100 and thus collectively lock the sump assembly 50 of the present invention.

Once the locking members 910 are fastened and drawn (tightened) to close the distance between the cover 600 and the sump housing 100, the upper and lower housings 550 and 510 of the water guide 500, which are disposed between the cover and the sump housing, become closely adhered to each other. In doing so, the seal 350 between the upper and lower housings 550 and 510 effectively prevents water pumped by the impeller 320 of the water supply pump 300 from leaking between the upper and lower housings.

Meanwhile, according to the present invention, the water guide 500 and the cover 600 may be joined together directly, i.e., without using a separate locking member, thereby preventing the occurrence of any gap between the water guide and the cover, and in doing so, preventing leaks in the supply of pumped water pumped being to the upper and lower arms 41 and 45 after being introduced into the first and second guide passages 555 and 557. Hence, the water introduced into the first and second guide passages 557 and 555 after pumping can be respectively supplied to the lower and upper arms 45 and 41 without water leakage. For this, at least one of the water guide 500 and the cover 600, which are preferably made of molded plastic, is partially fused using a localized heat source (not shown), enabling the water guide and the cover to be joined together before the fused portion solidifies. In other words, the water guide 500 and the cover 600 are fused together. Preferably, predetermined portions of the top surface of the upper housing 550, which defines the first and second guide passages 555 and 557, is fused to enable joining by pressing the upper housing to a bottom surface of the cover 600.

In the operation of the above-configured sump assembly according to the present invention, if the dishwasher initiates a washing or rinsing process, clean water is introduced into the recess 110 of the sump housing 100 via the water supply hole 120 connected to the water supply pipe 70. The water introduced into the recess 110 is then heated by the heater 210. If a corresponding water supply is completed, the motor 310 of the water supply pump 300 is driven so that the impeller 320 pumps the water stored in the recess 110. One portion of the pumped water flows in the valve receptacle 553 via the outlet 551 and is then output (guided) to one or both of the first and second guide passages 555 or 557 according to an operation of the diverting valve 810 and thus sprayed into the tub 20 from one or both spray arms. That is, water output to the first guide passage 555 is supplied to the upper arm 41 to be sprayed onto articles placed on the upper rack 31, while water output to the second guide passage 557 is supplied to the lower arm 45 to be sprayed onto articles placed on the lower rack 35. After washing, the used (contaminated) water drains to the bottom of the tub 20 and enters the sump assembly 50, to be reintroduced into the sump housing 100 via the drain apertures 620 provided in the cover 600 and again be stored in the recess 110. Large particles of the contaminants returned to the recess 110 of the sump housing 100 together with the draining water are ground by the disposal blades 150, disposed between the bottom of the recess and the impeller 320, while smaller particles are pumped along with the water.

Meanwhile, another portion of the water pumped by the impeller 320 is for immediate recirculation and is introduced into the bypass 556 and passes through the channel 710 of the sensor assembly 700 for water contaminant level determination. According to the determined water contaminant level, the dishwasher may adjust automatically a washing or rinsing duration or a number of wash/rinse repetitions.

The water having passed through the channel 710 of the sensor assembly 700 is introduced into the drain chamber 140 via the first and second drains 554 and 513. In doing so, with the drain pump 400 is inactive, the water is retained in the drain chamber 140 and enters (flows in) the soil chamber 515 via the third drain 511, whereby contaminants in the water are precipitated and filtering occurs as the water in the soil chamber 515 rises and overflows through the cover 600 and is forced out the overflow vents 615, through the mesh 610, and back into the drain apertures 620 to be re-introduced into the sump housing 100. Any contaminant particles that are introduced into the soil chamber 515 but are too large to pass through the mesh 610 simply accumulate in the soil chamber until a drain operation is performed by the drain pump 400 upon completion of a washing or rinsing cycle or when excess contaminant levels are determined, whereby the entire contents of the soil chamber 515, the drain chamber 140, and the recess 110 of the sump housing 100 are discharged via the drain hose 80. As described above, a prescribed quantity of the pumped water is passed through the bypass 556 to be purified by the filter 610 and is then re-supplied to the sump housing 100. In doing so, though the soil chamber 515 and the filter 610 may seem to be filtering only a small quantity or percentage of the water, since their operation is continuous throughout any washing or rinsing cycle, excellent water-filtering performance is achieved.

Accordingly, the cover, water guide, and sump housing configuring the sump assembly according to the present invention are collectively assembled and secured by the locking members, whereby the corresponding assembly work is facilitated. An upper part of the water guide and a lower part of the cover, which altogether define the guide passage for leading the pumped water to the spray nozzles, are directly joined together without using a separate locking member to leave no interceding gap. In addition, leakage of pumped water introduced into the guide passages is prevented by the locking members, which secure the cover, water guide, and sump housing, and by the seal provided between the upper and lower housings of the water guide. Therefore, the present invention supplies the pumped water to the spray nozzles without a pressure reduction due to leakage, thereby maintaining a predetermined water pressure and high dishwasher performance.

It will be apparent to those skilled in the art that various modifications and variations can be made in the present invention. Thus, it is intended that the present invention covers such modifications and variations provided they come within the scope of the appended claims and their equivalents.

What is claimed is:

1. A sump assembly of a dishwasher, comprising:
a sump housing for storing water;
a cover for covering said sump housing; and
a water guide provided within said sump housing and disposed under said cover, said water guide being directly joined to said cover and having at least one guide passage for outputting water.

2. The sump assembly of claim 1, further comprising:
a water supply pump, coupled with said sump housing, for pumping the stored water into the at least one guide passage.

3. The sump assembly of claim 2, wherein the water output from said water guide is pressurized.

4. The sump assembly of claim 1, wherein the water output from said water guide is supplied to a set of nozzles.

5. The sump assembly of claim 1, wherein at least one of said water guide and said cover is partially fused to enable the joining.

6. The sump assembly of claim 1, wherein said water guide and said cover are joined without using a separate locking member.

7. The sump assembly of claim 1, wherein the at least one guide passage is defined by opposing portions of said water guide and said cover.

8. The sump assembly of claim 1, wherein the at least one guide passage is defined by a top portion of said water guide and a bottom portion of said cover.

9. The sump assembly of claim 8, wherein at least one of the top and bottom portions are fused.

10. The sump assembly of claim 8, wherein the top portion of said water guide and the bottom portion of said cover are joined by fusing at least one of the top and bottom portions and then pressing the fused at least one portion to the other portion.

11. The sump assembly of claim 1, said water guide comprising:
an upper housing having a top surface forming the at least one guide passage, the top surface being joined directly to a bottom surface of said cover; and
a lower housing, disposed under said upper housing, said lower housing providing a soil chamber for receiving a portion of the water output from said water guide.

12. The sump assembly of claim 11, said cover comprising:
a mesh, disposed over the soil chamber, for filtering water exiting the soil chamber.

13. The sump assembly of claim 12, said cover further comprising:
at least one overflow vent for leading the filtered water to said sump housing.

14. The sump assembly of claim 11, said water guide further comprising:
an impeller, disposed between the upper and lower housings, for pumping the water into the at least one guide passage.

15. The sump assembly of claim 14, said water guide further comprising:
a seal, disposed between the upper and lower housings, for preventing leakage of the pumped water.

16. The sump assembly of claim 1, said cover comprising:
at least one drain aperture for leading contaminated water to said sump housing.

17. The sump assembly of claim 1, further comprising:
at least one locking member simultaneously securing said cover and said water guide to said sump housing.

18. The sump assembly of claim 17, wherein the at least one locking member passes through each of said cover and said water guide and is secured to said sump housing.

19. The sump assembly of claim 17, wherein the at least one locking member passes through at least one first hole formed in said cover and is received by a boss provided in said sump housing.

20. The sump assembly of claim 1, further comprising:
at least one supplementary locking member for supplementing the joining of said water guide to said cover.

21. The sump assembly of claim 20, wherein the at least one supplementary locking member passes through said cover and is secured to a top surface of said water guide.

22. The sump assembly of claim 20, wherein the at least one supplementary locking member serves to assemble to a top surface of said cover a nipple for communicating with the at least one guide passage of said water guide.

23. A sump assembly of a dishwasher, comprising:
a sump housing for storing water;
a cover for covering said sump housing; and
a water guide provided within said sump housing and disposed under said cover, said water guide having at least one guide passage for outputting water; and
at least one locking member simultaneously securing said cover and said water guide to said sump housing.

24. The sump assembly of claim 23, wherein the at least one locking member passes through each of said cover and said water guide and is secured to said sump housing.

25. The sump assembly of claim 23, wherein the at least one locking member passes through at least one first hole formed in said cover and is received by a boss provided in said sump housing.

26. The sump assembly of claim 23, wherein at least one of said water guide and said cover is partially fused to enable a joining of said water guide and said cover.

27. The sump assembly of claim 23, further comprising:
at least one supplementary locking member for supplementing the securing of said water guide to said cover.

28. The sump assembly of claim 27, wherein the at least one supplementary locking member passes through said cover and is secured to a top surface of said water guide.

29. The sump assembly of claim 27, wherein the at least one supplementary locking member serves to assemble to a top surface of said cover a nipple for communicating with the at least one guide passage of said water guide.

30. The sump assembly of claim 23, said water guide comprising:
an upper housing having a top surface forming the at least one guide passage; and
a lower housing, disposed under said upper housing, said lower housing providing a soil chamber for receiving a portion of the water output from said water guide.

31. The sump assembly of claim 23, said cover comprising:
a mesh, disposed over the soil chamber, for filtering water exiting the soil chamber.

32. The sump assembly of claim 23, further comprising:
a water supply pump, coupled with said sump housing, for pumping the stored water into the at least one guide passage.

33. The sump assembly of claim 23, said water supply pump comprising:
an impeller, disposed between the upper and lower housings, for pumping the water into the at least one guide passage; and
a seal, disposed between the upper and lower housings, for preventing leakage of the pumped water.

34. A sump assembly of a dishwasher, comprising:
a sump housing for storing water;
a cover for covering said sump housing; and
a water guide provided within said sump housing and disposed under said cover, said water guide having at least one guide passage for outputting water; and
at least one locking member securing said water guide to said sump housing.

35. The sump assembly of claim 34, further comprising:
at least one supplementary locking member passes through said cover and is secured to a top surface of said water guide.

36. The sump assembly of claim 35, wherein the at least one supplementary locking member serves to assemble to a top surface of said cover a nipple for communicating with the at least one guide passage of said water guide.

37. The sump assembly of claim 34, further comprising:
at least one locking member simultaneously securing said cover and said water guide to said sump housing.

38. The sump assembly of claim 37, wherein the at least one locking member passes through each of said cover and said water guide and is secured to said sump housing.

39. The sump assembly of claim 37, wherein the at least one locking member passes through at least one first hole formed in said cover and is received by a boss provided in said sump housing.

40. The sump assembly of claim 34, wherein at least one of said water guide and said cover is partially fused to enable a joining of said water guide and said cover.

41. The sump assembly of claim 34, said water guide comprising:
an upper housing having a top surface forming the at least one guide passage; and
a lower housing, disposed under said upper housing, said lower housing providing a soil chamber for receiving a portion of the water output from said water guide.

42. The sump assembly of claim 41, said cover comprising:
a mesh, disposed over the soil chamber, for filtering water exiting the soil chamber.

43. The sump assembly of claim 41, further comprising:
a water supply pump, coupled with said sump housing, for pumping the stored water into the at least one guide passage.

44. The sump assembly of claim 41, said water supply pump comprising:
an impeller, disposed between the upper and lower housings, for pumping the water into the at least one guide passage; and
a seal, disposed between the upper and lower housings, for preventing leakage of the pumped water.

45. A dishwasher, comprising:
a washing chamber for accommodating articles to be washed;
a sump assembly disposed under said washing chamber, said sump assembly comprising:
a sump housing for storing water;
a cover for covering said sump housing; and
a water guide provided within said sump housing and disposed under said cover, said water guide being directly joined to said cover and having at least one guide passage for outputting water;
a water supply pump, coupled with said sump housing, for pumping the stored water into the at least one guide passage; and
at least one spray arm for spraying the pumped water into said washing chamber toward the accommodated articles.
